(19) United States
(12) Patent Application Publication
(10) Pub. No.: US 2022/0337707 A1
(43) Pub. Date: Oct. 20, 2022

(54) DEVICE MONITORING APPARATUS, DEVICE MONITORING METHOD, AND IMAGE FORMING APPARATUS

(71) Applicant: Hiroshi ANDO, Kanagawa (JP)

(72) Inventor: Hiroshi ANDO, Kanagawa (JP)

(21) Appl. No.: 17/694,718

(22) Filed: Mar. 15, 2022

(30) Foreign Application Priority Data
Apr. 15, 2021 (JP) 2021-069332

(51) Int. Cl. H04N 1/00

(52) U.S. Cl. CPC H04N 1/00037; H04N 1/00323; H04N 1/00082; H04N 1/00891

(57) ABSTRACT

A device monitoring apparatus includes a sensor and a stopping unit. The sensor is configured to detect at least either smoke generation or ignition in a module included in an electronic device, based on at least one of a relative intensity of light generated in the module and a temperature of each module. The stopping unit is installed in the module and configured to stop an operation of the module in response to the at least one of the smoke generation and the ignition being detected by the sensor.

### CROSS-REFERENCE TO RELATED APPLICATIONS

The present application claims priority under 35 U.S.C. § 119 to Japanese Patent Application No. 2021-069332, filed on Apr. 15, 2021. The contents of which are incorporated herein by reference in their entirety.

### BACKGROUND OF THE INVENTION

### 1. Field of the Invention

The present invention is related to an device monitoring apparatus, a device monitoring method, and an image forming apparatus.

### 2. Description of the Related Art

A technique has been developed that, when an occurrence of ignition in an electronic device is detected by a sensor, activates a fire extinguisher placed on the outside of the electronic device, so that a fire extinguishing agent is sprayed inside the electronic device. However, in that technique, as a result of spraying the fire extinguishing agent from the fire extinguisher, there are times when the electronic device can no more be repaired.

In that regard, a technique has been developed by which, in a fixing device of an electrophotographic printer (an example of an electronic device), or in a drying device of an inkjet printer, or in an electrical equipment unit, the temperature of the concerned printer is detected using a temperature sensor; and, based on the detection result, the supply of electrical power from the electrical equipment unit to the fixing device and the drying device is stopped, and the conveyance of sheets (an example of a recording medium) is stopped by the electrical equipment unit, so that any damage to the inside and the outside of the printer is prevented.

In the technique mentioned above, the detection result about the temperature of the printer is referred to. However, due to the sensor-based variability in the detection result about the temperature of the printer, or due to the variability in the position of the temperature sensor, or due to the variability in the position of the heater; there are times when smoke generation or ignition occurring inside the printer cannot be correctly detected.

### SUMMARY OF THE INVENTION

According to an aspect of the present invention, a device monitoring apparatus includes a sensor and a stopping unit. The sensor is configured to detect at least either smoke generation or ignition in a module included in an electronic device, based on at least one of a relative intensity of light generated in the module and a temperature of each module. The stopping unit is installed in the module and configured to stop an operation of the module in response to the at least one of the smoke generation and the ignition being detected by the sensor.

### BRIEF DESCRIPTION OF THE DRAWINGS

FIG. 1 is a schematic diagram of an image forming apparatus according to an embodiment;

FIG. 2 is a diagram illustrating an example of a control unit of the image forming apparatus according to the present embodiment; and

FIG. 3 is a diagram for explaining an example of the wavelength regions of the light as detected by ignition sensors and discharge sensors installed in the image forming apparatus according to the present embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An embodiment has an object to provide a device monitoring apparatus, a device monitoring method, and an image processing device that can enhance the safety of the operation of an electronic device.

An exemplary embodiment of an device monitoring apparatus, a device monitoring method, and an image processing device is described below in detail with reference to the accompanying drawings.

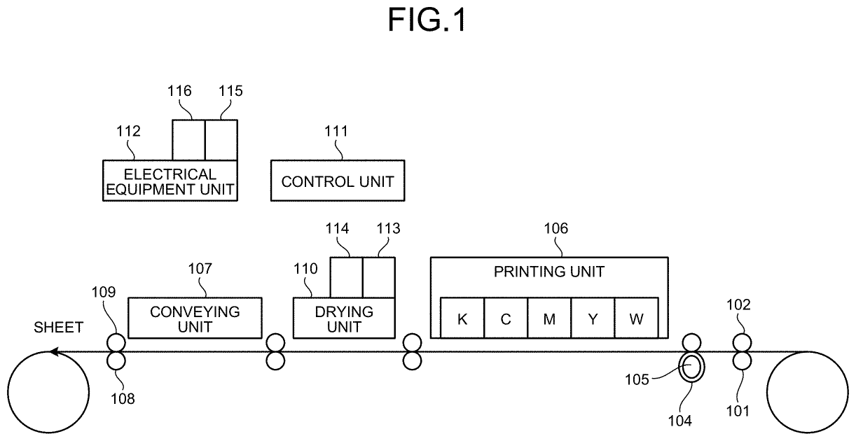

FIG. 1 is a schematic diagram of the image forming apparatus according to the present embodiment. The image forming apparatus according to the present embodiment (an example of an electronic device as well as an example of an device monitoring apparatus) is an inkjet printer. More particularly, as illustrated in FIG. 1, in the image forming apparatus, a recording medium W coming out from a paper feeding unit is conveyed toward a driven roller 105 using a paper feeding roller 101, which is coupled to a paper feeding motor, and a paper feeding driven roller 102; and is then conveyed to a printing unit 106.

The paper feeding roller 101 is coupled to a paper feeding motor. The driven roller 105 gets driven according to the conveyance of the recording medium W, and includes a recording-medium feed-amount detection encoder 104. The recording-medium feed-amount detection encoder 104 outputs a detection signal according to the movement of the recording medium W over a predetermined distance.

In the image forming apparatus, ink droplets are sprayed onto the recording medium W using an inkjet head array of the printing unit 106 that includes inkjet heads corresponding to black (K), cyan (C), magenta (M), yellow (Y), and white (W) colors. Then, in the image forming apparatus, a drying unit 110 dries the ink sprayed onto the recording medium W.

Moreover, in the image processing device, after the ink on the recording medium W has been dried, the recording medium W is conveyed toward a conveying unit 107, and is further conveyed using a paper ejection roller 108 and a paper ejection driven roller 109. As a result, the recording medium W gets ejected to the outside of the image forming apparatus. The paper ejection roller 108 is coupled to a paper ejection motor that is driven by the conveying unit 107. According to the present embodiment, in the image forming apparatus, the recording-medium feed-amount detection encoder 104 is installed in between the paper feeding roller 101 and the printing unit 106. Alternatively, the recording-medium feed-amount detection encoder 104 can be installed in between the printing unit 106 and the paper ejection roller 108.

The image forming apparatus also includes a control unit 111 that performs overall control of the image forming apparatus; as well as includes an electrical equipment unit 112 that supplies electrical power to the modules such as the control unit 111, the printing unit 106, the conveying unit 107, and the drying unit 110. In the present embodiment, the electrical equipment unit 112 supplies electrical power to those modules via a harness.

In the present embodiment, although the electrical equipment unit 112 supplies electrical power to the modules by wire using a harness, that is not the only possible case. Alternatively, the electrical equipment unit 112 can supply electrical power to the modules wirelessly.

The control unit 111 outputs control signals to the modules such as the conveying unit 107, the drying unit 110, the electrical equipment unit 112, a display unit 117, and a communication unit 118; and accordingly controls those modules. Meanwhile, in the present embodiment, the modules such as the printing unit 106, the drying unit 110, the conveying unit 107, the control unit 111, the electrical equipment unit 112, the display unit 117, and the communication unit 118 are housed in independent housings. Moreover, in the present embodiment, the modules receive input of the control signals from the control unit 111 via wireless communication.

In the first embodiment, although the control unit 111 inputs control signals to the modules via wireless communication, that is not the only possible case. Alternatively, the control signals can be input to the modules via wired communication using a harness.

Meanwhile, the image forming apparatus also includes ignition sensors 113 and 115 and discharge sensors 114 and 116. The ignition sensor 113 is a sensor that, based on the relative intensity of the light generated in the drying unit 110, detects if ignition is occurring in the drying unit 110. The relative intensity represents the proportion of the light energy of the light generated in the drying unit 110 with reference to the light energy set in advance. In case ignition is detected in the drying unit 110, the ignition sensor 113 sends detection signals to the conveying unit 107, the drying unit 110, the control unit 111, and the electrical equipment unit 112.

More particularly, the ignition sensor 113 calculates the relative intensity of the light that, out of the light generated in the drying unit 110, is present in an ignition detection region. The ignition detection region represents a wavelength region that includes the infrared region representing the wavelength region of infrared light. Then, if the calculated relative intensity is greater than a predetermined relative intensity, the ignition sensor 113 detects that ignition has occurred in the drying unit 110. The predetermined relative intensity represents the relative intensity at which ignition is determined to have occurred in the drying unit 110.

Herein, the explanation is given about an example in which the ignition sensor 113 detects that ignition has occurred in the drying unit 110. In an identical manner, the ignition sensor 115 can detect that ignition has occurred in the electrical equipment unit 112.

The discharge sensor 114 is a sensor that, based on the relative intensity of the light occurring in the drying unit 110, detects if smoke is generated (or sparking has occurred) in the drying unit 110. Then, if smoke generation is detected in the drying unit 110, the discharge sensor 114 transmits control signals to the drying unit 110, the control unit 111, and the electrical equipment unit 112.

More particularly, the discharge sensor 114 calculates the relative intensity of the light in a discharge detection wavelength region out of the light generated in the drying unit 110. The discharge detection wavelength region represents a wavelength region including the wavelength region of the ultraviolet light. If the calculated relative intensity is greater than a predetermined relative intensity, then the discharge sensor 114 detects that smoke is generated in the drying unit 110.

Herein, the explanation is given about an example in which the discharge sensor 114 detects smoke generation in the drying unit 110. In an identical manner, the discharge sensor 116 can detect smoke generation in the electrical equipment unit 112.

In the present embodiment, the ignition sensors 113 and 115 and the discharge sensors 114 and 116 are installed in the electrical equipment unit 112 and the drying unit 110. However, sensors for detecting ignition and smoke generation can be installed also in the other modules of the image forming apparatus (for example, the printing unit 106, the conveying unit 107, and the control unit 111).

Moreover, in the present embodiment, the ignition sensors 113 and 115 and the discharge sensors 114 and 116 are used to detect ignition and smoke generation in the electrical equipment unit 112 and the drying unit 110. However, that is not the only possible case. Alternatively, it is possible to detect at least either ignition or smoke generation in the electrical equipment unit 112 and the drying unit 110.

Moreover, in the present embodiment, the ignition sensors 113 and 115 and the discharge sensors 114 and 116 are used to detect ignition and smoke generation in the electrical equipment unit 112 and the drying unit 110 based on the relative intensity of the light in the discharge detection wavelength region and the ignition detection wavelength region. However, that is not the only possible case.

Alternatively, for example, the ignition sensors 113 and 115 and the discharge sensors 114 and 116 can be cameras (imaging units) configured to be capable of detecting the visible light. In that case, the ignition sensors 113 and 115 and the discharge sensors 114 and 116 take images of the electrical equipment unit 112 and the drying unit 110; and, based on the brightness of the images, calculate the relative intensity of the discharge detection wavelength region and the ignition detection wavelength region.

Then, based on the relative intensities, the ignition sensors 113 and 115 and the discharge sensors 114 and 116 can detect the ignition and the smoke generation in the electrical equipment unit 112 and the drying unit 110.

Alternatively, the ignition sensors 113 and 115 and the discharge sensors 114 and 116 detect the temperature of the electrical equipment unit 112 (for example, the substrate in the electrical equipment unit 112) and the temperature of the drying unit 110 (for example, the substrate in the drying unit 110). Then, based on the result of temperature detection, the ignition sensors 113 and 115 and the discharge sensors 114 and 116 can detect the ignition and the smoke generation in the electrical equipment unit 112 and the drying unit 110.

That is, the ignition sensors 113 and 115 and the discharge sensors 114 and 116 represent examples of sensors that, at least either based on the relative intensities of the light generated in the modules such as the electrical equipment unit 112 and the drying unit 110 or based on the temperatures of the modules, can detect at least either the smoke generation or the ignition in those modules.

In the present embodiment, in the image forming apparatus of the liquid discharge type, image formation is performed by making impacts of inks onto a medium made of paper, thread, fiber, fabric, leather, metal, plastic, glass, wood, or ceramic.

Herein, image formation not only includes adding an image, which has a meaning in the form of characters or diagrams, onto a medium; but also includes adding an image such as a pattern, which does not have any particular meaning, onto the recording medium W (i.e., also includes simply making an impact of droplets onto a medium).

Meanwhile, the term “ink” is not limited to an object that is referred to as ink; but is used as the collective naming for all types of liquids usable in image formation, such as a recording liquid, a fixing liquid, resin, or an object referred to as a liquid.

Moreover, a sheet representing an example of the recording medium W is not limited to be made of paper and also includes a medium such as an OHP sheet or a cloth to which ink droplets get attached; and serves as the collective naming indicting a medium for recording, a recording medium, recording paper, and a recording sheet.

Furthermore, the term “image” is not limited to a planar image; and also includes an image added to a stereoscopic object or an image formed by performing three-dimensional modeling of a stereoscopic object.

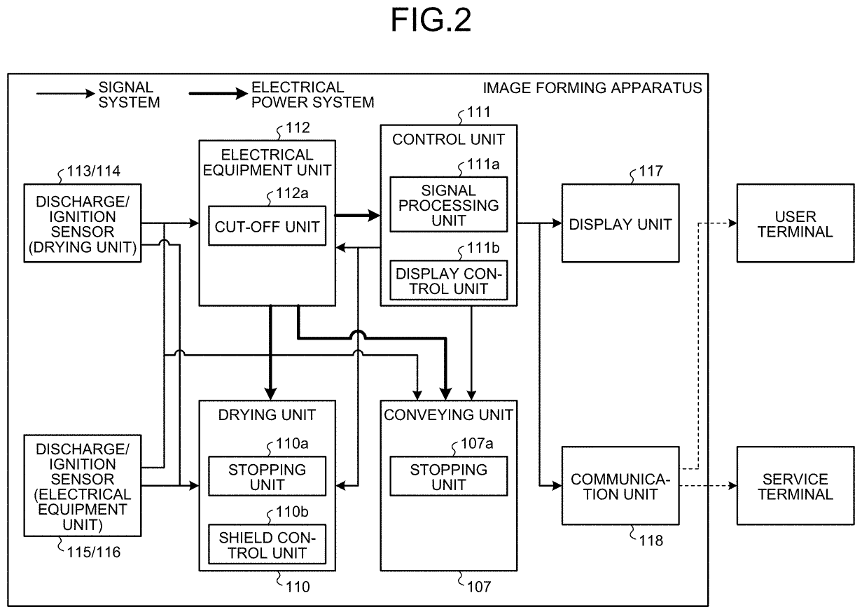

FIG. 2 is a diagram illustrating an example of the control unit of the image forming apparatus according to the present embodiment. The control unit 111 of the image forming apparatus according to the present embodiment controls the various modules of the image forming apparatus, such as the electrical equipment unit 112, the conveying unit 107, the drying unit 110, the display unit 117, and the communication unit 118. The electrical equipment unit 112 supplies electrical power to the various modules of the image forming apparatus such as the control unit 111, the conveying unit 107, and the drying unit 110.

According to the present embodiment, in the image forming apparatus, when the discharge sensors 114 and 116 and the ignition sensors 113 and 115 that are installed in the drying unit 110 and the electrical equipment unit 112 detect smoke generation or ignition, the following three termination operations from (1) to (3) are performed.

(1) The detection signals that are output from the discharge sensors 114 and 116 and the ignition sensors 113 and 115 are transmitted to a stopping unit 110a of the drying unit 110 and to a stopping unit 107a of the conveying unit 107. When at least either ignition or smoke generation is detected by the discharge sensors 114 and 116 and the ignition sensors 113 and 115, the stopping unit 110a switches off the relay and the contactors in the drying unit 110, so that the supply of electrical power from the electrical equipment unit 112 to the heater inside the drying unit 110 is cut off. As a result, the operations of the drying unit 110 are stopped.

Thus, when ignition or smoke generation is detected in the drying unit 110, the operations of the drying unit 110 can be promptly stopped, thereby preventing the other modules from getting affected by the drying unit 110. That enables achieving enhancement in the safety of the recording medium W, such as a sheet, and the safety of the other components.

Moreover, when at least either ignition or smoke generation is detected by the discharge sensors 114 and 116 and the ignition sensors 113 and 115, the stopping unit 107a switches off the relay and the contactors in the conveying unit 107, so that the supply of electrical power from the electrical equipment unit 112 to the heater inside the conveying unit 107 is cut off. As a result, the operations of the conveying unit 107 are stopped.

Furthermore, also when a sheet causes an emergency condition, the stopping unit 107a stops the conveyance of the sheet to the outside of the conveying unit 107. As a result, when ignition or smoke generation is detected in the conveying unit 107, the operations of the conveying unit 107 can be promptly stopped, thereby preventing the other modules from getting affected by the conveying unit 107. That enables achieving enhancement in the safety of the other parts (modules).

Meanwhile, the drying unit 110 can also include a paper conveyance entry-exit port (an example of an opening) through which sheets come in and go out, and include a shielding member (for example, a metal plate) that is disposed at the paper conveyance entry-exit port for shielding the paper conveyance entry-exit port. In that case, when at least either ignition or smoke generation is detected by the discharge sensors 114 and 116 and the ignition sensors 113 and 115, a shield control unit 110b of the drying unit 110 shields the paper conveyance entry-exit port using the shielding member.

As a result, when ignition or smoke generation is detected in the drying unit 110, the operations of the drying unit 110 can be promptly stopped, thereby effectively preventing the other modules from getting affected by the drying unit 110. That enables achieving enhancement in the safety of the other parts.

In the present embodiment, the shielding member and the shield control unit are disposed only in the drying unit 110. Similarly, when any other module (for example, the conveying unit 107) includes an opening such as the paper conveyance entry-exit port, a shielding member and a shield control unit can be disposed in that module to. As a result, when at least either ignition or smoke generation is detected by the discharge sensors 114 and 116 and the ignition sensors 113 and 115, that opening can be shielded using the shielding member in an identical manner.

(2) The detection signals that are output from the discharge sensors 114 and 116 and the ignition sensors 113 and 115 are transmitted to the electrical equipment unit 112. When at least either ignition or smoke generation is detected by the discharge sensors 114 and 116 and the ignition sensors 113 and 115, a cut-off unit 112a of the electrical equipment unit 112 stops (cuts off) the supply of electrical power from the electrical equipment unit 112 to the conveying unit 107 and the drying unit 110.

(3) The detection signals that are output from the discharge sensors 114 and 116 and the ignition sensors 113 and 115 are transmitted to the control unit 111. When at least either ignition or smoke generation is detected by the discharge sensors 114 and 116 and the ignition sensors 113 and 115, a signal processing unit 111a of the control unit 111 turns off the control signals with respect to the relay and the contactor in the drying unit 110 and turns off the control signals with respect to the relay and the contactor in the conveying unit 107.

Meanwhile, the control unit 111 can also include a storing unit (a memory unit) for storing the detection result of at least either ignition or smoke generation as obtained by the discharge sensors 114 and 116 and the ignition sensors 113 and 115.

According to the preconfigured settings performed by the user or a service, the drying unit 110 can also include fire extinguishing equipment (an example of a fire extinguishing unit). In that case, when at least either ignition or smoke generation is detected by the discharge sensors 114 and 116 and the ignition sensors 113 and 115, the fire extinguishing equipment extinguishes the fire in the drying unit 110. Moreover, when a coordinating unit is included for coordinating with the fire extinguishing equipment of the image forming apparatus; according to the preconfigured settings performed by the user or a service, fire extinguishing is performed using the fire extinguishing equipment provided in the installation environment.

Meanwhile, when at least either ignition or smoke generation is detected by the discharge sensors 114 and 116 and the ignition sensors 113 and 115, a display control unit 111b of the control unit 111 displays an error in the display unit 117. Moreover, the display control unit 111b can also perform the following operations: flashing an error display light; warning the user using an error warning sound; and transmitting error information to the user terminal or the service terminal via the communication unit 118. As a result, the fact that the image forming apparatus is in the emergency stop condition can be notified to the user terminal or the service terminal. That enables achieving reduction in the stoppage time of the image forming apparatus.

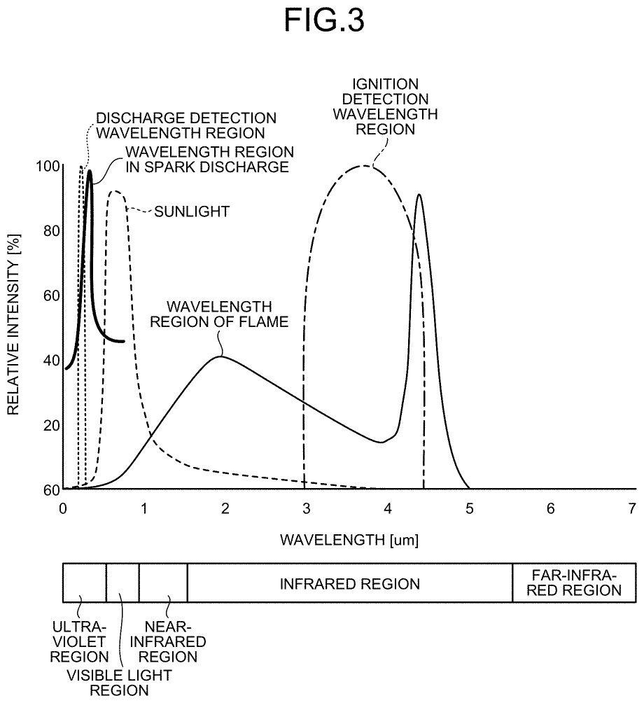

FIG. 3 is a diagram for explaining an example of the wavelength regions of the light as detected by the ignition sensors and the discharge sensors installed in the image forming apparatus according to the present embodiment. In FIG. 3, the horizontal axis represents the wavelength region (μm) of light; and the vertical axis represents the relative intensity (%) of the energy of the lights having difference wavelength regions.

As illustrated in FIG. 3, the discharge sensors 114 and 116 are capable of detecting the light of the discharge detection wavelength region that includes at least some part of the wavelength region of the ultraviolet light (i.e., some part of the ultraviolet region) generated due to electrical sparking. In an electronic device such as an image forming apparatus, electrical sparking occurs in the harness connection portion or the connector connection portion due to electrical deterioration/poor operation; and there are times when the electrical sparking causes ignition in the harness, or the connector, or the connection components, or the peripheral components.

At the time of occurrence of electrical sparking, a light in the wavelength region of ultraviolet light (i.e., in the ultraviolet region) is generated. Hence, by installing the discharge sensors 114 and 116 capable of detecting the light in the ultraviolet region, sparking (smoke generation) can be detected before the occurrence of ignition. That enables achieving enhancement in the safety of the image forming apparatus.

Moreover, as illustrated in FIG. 3, the ignition sensors 113 and 115 are capable of detecting the light in the ignition detection wavelength region that includes at least some part of the wavelength region of the infrared light (i.e., some part of the infrared region) generated due to ignition occurring only for a moment. Hence, in case ignition occurs in a continuous manner, the ignition sensors 113 and 115 detect the ignition. That enables achieving enhancement in the safety of the image forming apparatus. As a result of using such two types of sensors, it becomes possible to perform two types of detection, thereby enabling achieving a safer device.

In this way, in the image forming apparatus according to the present embodiment, when ignition or smoke generation is detected in the drying unit 110, the operations of the drying unit 110 can be immediately stopped, thereby preventing the other modules from getting affected by the drying unit 110. That enables achieving enhancement in the safety of the recording medium W, such as a sheet, and the safety of the other parts.

Meanwhile, in the present embodiment, the image forming apparatus according to the present invention is used in a multifunction peripheral equipped with at least two functions from among the copying function, the printing function, the scanning function, and the facsimile function. However, alternatively, the image forming apparatus can be used in any type of image forming apparatus such as a copying machine, a printer, a scanner device, or a facsimile device.

According to an embodiment, it is possible to enhance the safety of the operation of an electronic device.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A device monitoring apparatus comprising:
a sensor configured to detect one of smoke generation and ignition in a module included in an electronic device, based on at least one of a relative intensity of light generated in the module and a temperature of each module; and
a stopping unit installed in the module and configured to stop an operation of the module in response to the at least one of the smoke generation and the ignition being detected by the sensor.

2. The device monitoring apparatus according to claim 1, further comprising a cut-off unit disposed in an electrical equipment unit configured to supply electrical power to the module, and configured to cut off electrical power supply from the electrical equipment unit to the module, in response to the at least one of the smoke generation or the ignition being detected by the sensor.

3. The device monitoring apparatus according to claim 2, wherein
the module is configured to be controlled by a control signal input from a control unit, and
the device monitoring apparatus further comprises a signal processing unit configured to turn off the control signal in response to the at least one of the smoke generation and the ignition being detected by the sensor.

4. The device monitoring apparatus according to claim 1, further comprising a storing unit configured to store detection result about detection of the at least one of the smoke generation and the ignition by the sensor.

5. The device monitoring apparatus according to claim 1, wherein
the module includes a shielding member configured to shield an opening of the module, and
the device monitoring apparatus further comprises a shield control unit configured to shield the opening using the shielding member in response to the at least one of the smoke generation and the ignition being detected by the sensor.

6. The device monitoring apparatus according to claim 3, wherein
the module includes a plurality of modules, and
each of the plurality of modules is housed in an independent housing, and is configured to receive the control signal from the control unit via wireless communication or wired communication, and receive electrical power from the electrical equipment unit wirelessly or by wire.

7. The device monitoring apparatus according to claim 1, wherein
the module comprises a drying unit including a fire extinguishing unit, and
the fire extinguishing unit is configured to perform fire extinguishing in the drying unit in response to the at least one of the smoke generation and the ignition being detected by the sensor.

8. The device monitoring apparatus according to claim 1, further comprising a display control unit configured to display an error on a display unit in response to the at least one of the smoke generation or the ignition being detected by the sensor.

9. A device monitoring method implemented in a device monitoring apparatus, comprising:
detecting, by a sensor, at least one of smoke generation and ignition in a module included in an electronic device, based on one of a relative intensity of light generated in the module and a temperature of each module; and
stopping, by a stopping unit, an operation of the module in response to the at least one of the smoke generation and the ignition being detected by the sensor.

10. An image forming apparatus comprising:
a module;
a sensor configured to detect at least one of smoke generation and ignition in the module, based on at least one of a relative intensity of light generated in the module and a temperature of each module; and
a stopping unit installed in the module and configured to stop an operation of the module in response to the at least one of the smoke generation and the ignition being detected by the sensor.
